(19) United States
(12) Patent Application Publication
(10) Pub. No.: US 2026/0014761 A1
(43) Pub. Date: Jan. 15, 2026

(54) Polypropylene-Based Material For Fuse Welding Repairs On Automotive Plastic Components

(71) Applicant: 4Plastic, Inc., Crystal Lake, IL (US)

(72) Inventor: Mario Dimovski, Crystal Lake, IL (US)

(21) Appl. No.: 19/270,346

(22) Filed: Jul. 15, 2025

Related U.S. Application Data
(60) Provisional application No. 63/671,349, filed on Jul. 15, 2024.

(51) Int. Cl. B29C 73/04; B29C 59/02; B29C 65/02; B29K 23/00; B29K 105/26; B29K 509/02; C08K 3/34

(52) U.S. Cl. CPC B29C 73/04; B29C 59/02; B29C 65/022; C08K 3/34; B29C 2059/027; B29K 2023/16; B29K 2105/26; B29K 2509/02; B29K 2995/0012; B29K 2995/002; C08K 2201/005

(57) ABSTRACT

A heat welding composition and method for the repair of vehicle body components, particularly thermoplastic bumpers manufactured from polypropylene/EPDM. The composition includes a polypropylene base resin, talc filler, and optional additives, so as to be optimized for fusion-welding plastic to plastic automotive substrates. The method allows the material to be extruded into strips, applied with standard heat welding tools, and fused directly to damaged parts. The composition and method eliminate the need for structural fillers and enables OEM-grade repairs with improved durability, sustainability, and speed.

### RELATED APPLICATIONS

This application claims the filing priority of U.S. Provisional Application No. 63/671,349 titled “HEAT WELDING COMPOSITION AND METHOD FOR REPAIRING A VEHICLE BODY” and filed on Jul. 15, 2024. The '349 Provisional application is hereby incorporated by reference.

### TECHNICAL FIELD OF THE INVENTION

The present invention relates to automotive body repair materials. More particularly, it relates to a heat-weldable thermoplastic composition formulated specifically for seamless integration with polypropylene and/or polypropylene/EPDM automotive parts such as bumper covers—eliminating the need for structural fillers, promoting sustainability, and improving repair integrity.

### BACKGROUND OF THE INVENTION

Vehicle bumpers serve as both shock absorbers and protective fascia. Modern bumpers are typically composed of plastic substrates such as polypropylene (PP), often modified with ethylene propylene diene monomer (EPDM) to provide flexibility and durability. These materials can be expensive to replace and difficult to repair using traditional methods, which often involve the use of two-part epoxies and filler compounds incompatible with the native bumper substrate.

Existing repair solutions do not offer a direct material match to OEM bumper materials, frequently resulting in filler-heavy repairs that fail to meet OEM finish and performance standards. These repairs can shrink, crack, or fail under stress or heat exposure, requiring rework and resulting in higher lifecycle repair costs.

Compared to epoxy and traditional filler-based repair systems, the disclosed compositions and methods (1) provide true thermoplastic fusion, rather than mechanical adhesion, (2) eliminate the need for polyester fillers, reducing VOCs and shrinkage, (3) deliver a 100% recyclable solution aligned with circular economy models, (4) enable reduction in cost, time, and material waste during repairs, and (5) allow higher throughput and standardized techniques across technicians and regions.

Until the invention of the present application, these and other problems in the prior art went either unnoticed or unsolved by those skilled in the art.

### SUMMARY OF THE INVENTION

There is disclosed herein an improved automotive component repair composition, system, and method which avoid the disadvantages of prior system and methods while affording additional structural and operating advantages.

Generally speaking, the disclosed polymer blend for use in plastic welding repair of damaged automotive parts comprises an amount of a copolymer polypropylene in the range of about 74.5-79.5 percent by weight, an amount of magnesium silicate having a 15-35 mesh size in the range of about 20-25 percent by weight, and an amount of colorant, added as needed to achieve a desired color.

The disclosed method for repairing a thermoplastic automotive component is comprised of identifying and evaluating damage to a plastic automotive component, cleaning a damaged area of the component to identify a base plastic composition of the component, creating a channel on both the inside and outside surfaces of the damaged area of the component, selecting at least one weld strip composed of a polypropylene/EPDM blend compatible with the base plastic composition, heat-fusing the at least one weld strip into the inside surface channel at a temperature sufficient to soften both the at least one weld strip and the base plastic composition, heat-fusing the at least one weld strip into the outside surface channel at a temperature sufficient to soften both the at least one weld strip and the base plastic composition, applying downward pressure during the heat-fusing step to ensure adequate fusion of materials, cooling the fused materials with compressed air to form a weld, mechanically leveling the weld using steel files specifically designed for plastic, wherein 2% to 4% of surface thickness is removed, and then applying primer over the repaired area to restore original part thickness.

In specific embodiments, the weld strip is applied to the damaged area at an approximate 90-degree angle and a heat nozzle used to apply heat is held at about a 45-degree angle (±5 degrees) relative to the component surface. Similarly, a channel is preferably created in both an inside and outside of the damaged area using an SC-3 carbide bur to a depth of approximately 50% of the plastic thickness.

Further, a plastic repair system for automotive body components is disclosed and claimed. The repair system generally comprises a weld strip composed of a heat-fusible polypropylene/EPDM blend, a heat application tool operating between 1100-1200° F. (600-650° C.), a plastic shaping push tool designed for manual manipulation of heated thermoplastic, and a file tool set configured to shave and smooth thermoplastic material with minimal material loss (2% to 4%).

In specific embodiments, the plastic repair system further comprises a procedural guide specifying dual-sided channel creation, weld fusion technique, file-finishing process, and optional primer thickness to restore original part dimensions.

Finally, a method for reshaping a thermoplastic automotive component having a non-split deformation is described and claimed. The method generally comprises the steps of sanding an area of a non-split deformation to expose raw thermoplastic material, heating the exposed raw thermoplastic material at the area using a heat gun, using a plastic push tool to manually reshape the area of the component into its original geometry, repeating the heating and reshaping steps as needed, finishing the reshaped area with a steel file configured for plastic use, wherein protrusions within the area of up to 0.05 mm in height are removed, removing from about 2.0% to 4.0% of thickness of the area using the steel file, and applying a primer to return the area to OEM thickness.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a front view showing an embodiment of two welding strips comprised of the disclosed material and useable for the disclosed method;

FIG. 2 is a side view of a welding strip comprised of the disclosed material; and

FIG. 3 is a schematic showing a preferred welding process.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

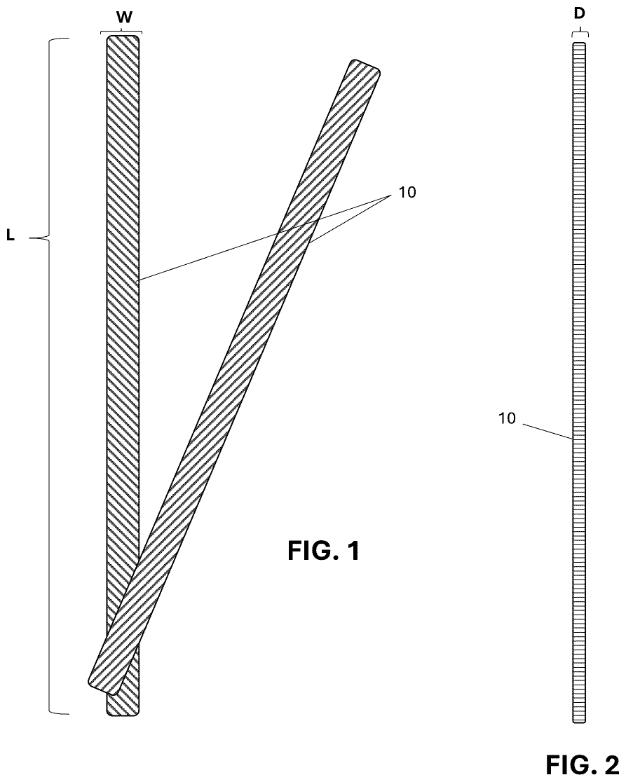

Referring to the following description, including appended FIGS. 1 and 2, the welding strip of the present disclosure is generally designated by the numeral 10. The particular illustrated welding strip 10 is for repairing automotive body parts. However, while all the embodiments described and illustrated are directed to an automotive welding strip, it should be understood that the principles of the invention can be more broadly applied to other plastic parts in need of repair.

As can be seen in FIGS. 1-3, the welding strip 10 has a length (L), width (W), and thickness (D) which can easily be varied for specific applications. Preferred parameters are about 14 in (L)×⅜ in (W)× 1/16 in (D) or about 35.6 cm×0.953 cm×0.159 cm. The welding strips 10 can be color-matched to just about any automotive plastic used in the industry, as well.

### Example Composition:

In a preferred embodiment, the material is comprised primarily of a polypropylene copolymer base for an optimized impact resistance and flexibility (e.g., Izod rating of 3.0-3.5 ft-lbs/in, see ASTM D256). The preferred polypropylene resin is blended with the following components, by weight:
Copolymer Polypropylene (virgin PP): 74.5-79.5 lbs
Magnesium silicate (e.g., TALCRON™) (15-35 mesh talc filler): 20-25 lbs
Colorant (e.g., CS12K582P): 0.5-1.0 lbs (or as required by processor)

The colorant, preferably black or gray, can be adjusted based on visual requirements. No UV stabilizers or adhesion promoters are required unless specified for performance. The copolymer polypropylene is preferably comprised of a 50/50 blend of polypropylene monomer and EPDM. A range of about 50-80 parts PP and 50-80 parts EPDM is preferred.

The resulting compound has a melt flow rate of approximately 30 g/10 min (±2 g/10 min) and an ash content of 22.2% (±1.5%), aligning closely with automotive-grade PP/EPDM substrates. If excessive moisture is present, each of the components (collectively or individually) may be pre-dried (about 2 hours at 80-100° C.) to achieve the desirable moisture content.

Variations of the preferred formulation may include modifications to the talc loading or the use of recycled PP/EPDM pellets to support circular manufacturing initiatives. The product may also be adapted for robotic or automated repair systems.

To begin production of welding strips 10, the following equipment is needed:
Twin- or single-screw extruder (preferred: twin screw for uniform melt)
Water bath or air-cooling system
Strand pelletizer
Classifier (screen system for pellet size control)

Based on the above formula, all components are accurately weighed and introduced into the bin of a high-shear industrial mixer. The mixer is then operated for a period of about 2 hours, which can vary based on factors understood by those of skill in the art, until a uniform composition of the ingredients is achieved. If moisture is present in the final composition, it can be dried or desiccated for at least a couple hours to bring the moisture content to within a range of 0.1% to 0.2% (or 1,000 to 2,000 ppm). Achieving this low moisture level is important because excess moisture during welding or fusion may result in undesirable issues such as surface bubbles, internal voids, weakened weld joints, poor cosmetic finish, and outgassing during fusion, which reduces bond strength.

Once the mixing is complete and dried, as necessary, extrusion and pelletizing of the material is required. To do this, the uniform composition is processed via twin or single-screw extrusion equipment at a temperature profile aligned with polypropylene melt behavior (i.e., 320° F. or 160° C. melt temperature at ambient). The preferred extrusion profile is characterized as:
Zone 1: 180° C.
Zone 2: 200° C.
Zone 3: 220° C.
Die Head: 230-240° C.

This profile can be adjusted depending on an actual resin melt index and equipment capability.

Pelletizing of the mixture is achieved by feeding the dry blend into an extruder hopper.

The blend is melted and homogenized through barrel zones, keeping shear low to avoid any degradation. The melt can then be extruded through a strand die and cooled via a water bath or air chute. The extruded product is preferably pelletized into uniform 3 mm granules, which should be screened for sizing consistency with oversized pellets and fines being removed. The final pellets should be packaged in moisture-proof bags.

These final packaged pellets can then be sent for distribution or further processing into weldable repair strips or welding strips 10, as shown in FIG. 1. Again, extrusion molding is used to form flat, rod-shaped, or triangular strips 10 having a 3-5 mm thickness (D). The strips 10 can then be bundled and packaged for technician use. The finished strips 10 should be stored in a dry, cool location out of direct sunlight. The packaging should be sealed to prevent moisture absorption. Finished strips 10 have a shelf life or about 12 months under these optimal conditions. Quality control checks can be performed with the following parameters:
Melt Flow Rate: 28-32 g/10 min (ASTM D1238)
Izod Impact (notched): 3.0-3.5 ft-lbs/in (ASTM D256)
Ash Content: 21-23% (TGA or ISO 3451)
Shore D-Hardness: ˜65-70
Visual Color Match: per client/OEM standard

After the final pellets are extruded into weldable strips 10, they are ready to be used in automotive body part repairs. Accordingly, the present disclosure also includes the method by which the welding strip 10 can be used in vehicle body repair. The preferred process consists of four key steps: (1) surface preparation, (2) welding, (3) bonding, and (4) finishing.

For surface preparation, the damaged area of the automotive body part (e.g., a polypropylene car bumper) is thoroughly cleaned, as is known in the art, and slightly abraded to create a roughened surface for adequate adherence of material. Where possible, a channel is made using an SC-3 carbide bur (or similar tool) to a depth of approximately 50% of the plastic thickness.

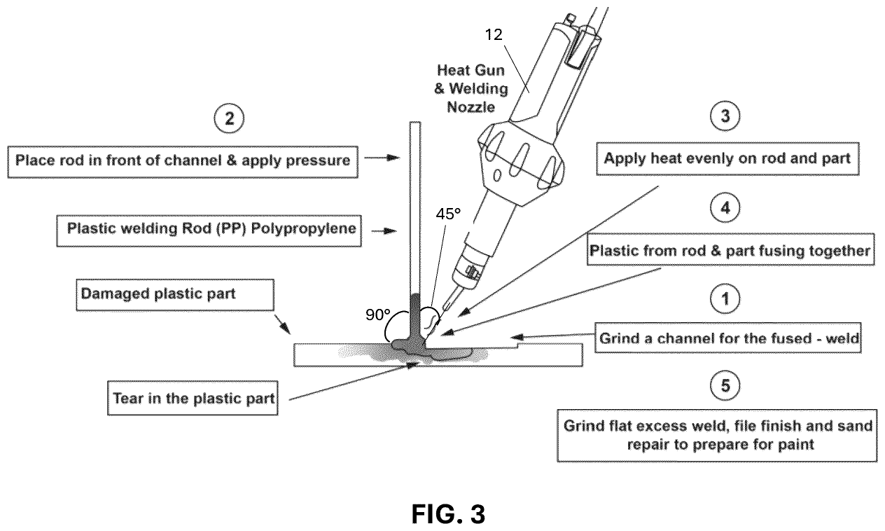

With reference to FIG. 3, the welding strip 10 is placed or held to the abraded area (and/or within the channel) at about a 90-degree angle and, using a heat welding gun or extrusion welder 12 at approximately 45-degree angle, the material of the welding strip 10 is applied to the cracked, torn, or missing section of the polypropylene bumper. As it softens, the welding strip 10 fuses with the OEM part, the material blending with the native material without requiring additional fillers. This welding process may be performed on both the inside and outside surface of the damaged area for best results. Though not shown, support tape or similar structure may be used on the inside surface of the damaged area during heat-welding of the outside surface to prevent what is known as “weld sink” on the component. To finish the damaged area, the repair is shaved flush with a plastic shaping tool and prepared for primer and paint. Because the material composition matches that of the OEM bumper substrate, the result is a seamless, permanent repair that meets or exceeds OEM durability and flexibility expectations.

In alternate embodiments, the formulation may include modifications to the talc loading or the use of recycled PP/EPDM pellets to support circular manufacturing initiatives. The product may also be adapted for robotic or automated repair systems.

The matter set forth in the foregoing description and accompanying drawings is not offered as a limitation, but by way of illustration only. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for repairing a thermoplastic automotive component, comprising:
identifying and evaluating damage to a plastic automotive component;
cleaning a damaged area of the component to identify a base plastic composition of the component;
creating a channel on both the inside and outside surfaces of the damaged area of the component;
selecting at least one weld strip composed of a polypropylene/EPDM blend compatible with the base plastic composition;
heat-fusing the at least one weld strip into the inside surface channel at a temperature sufficient to soften both the at least one weld strip and the base plastic composition;
heat-fusing the at least one weld strip into the outside surface channel at a temperature sufficient to soften both the at least one weld strip and the base plastic composition;
applying downward pressure during the heat-fusing step to ensure adequate fusion of materials;
cooling the fused materials with compressed air to form a weld;
mechanically leveling the weld using steel files specifically designed for plastic, wherein 2% to 4% of surface thickness is removed; and
applying primer over the repaired area to restore original part thickness.

2. The method of claim 1, wherein the at least one weld strip is applied to the damaged area at a 90-degree angle and a heat nozzle used to apply heat is held at a 45-degree angle relative to the component surface.

3. The method of claim 1, wherein creating a channel is performed using a SC-3 carbide bur to a depth of approximately 50% of the plastic thickness.

4. The method of claim 1, wherein the weld support tape is applied to the inside of the part to prevent weld sink during fusion on the outside surface.

5. The method of claim 2, further comprising manually levelling any deformation nibs on the component using file tools.

6. The method of claim 5, further comprising inspection of the repair using a contour gauge to confirm OEM styling line alignment.

7. A plastic repair system for automotive body components, comprising:
a weld strip composed of a heat-fusible polypropylene/EPDM blend;
a heat application tool operating between 1100-1200° F. (600-650° C.);
a plastic shaping push tool designed for manual manipulation of heated thermoplastic; and
a file tool set configured to shave and smooth thermoplastic material with minimal material loss (2% to 4%).

8. The plastic repair system of claim 7, further comprising a procedural guide specifying dual-sided channel creation, weld fusion technique, file-finishing process, and optional primer thickness to restore original part dimensions.

9. The plastic repair system of claim 7, wherein the files have teeth optimized for thermoplastic cutting in a single direction.

10. A polymer blend for use in plastic welding repair of damaged automotive parts, the blend comprising:
an amount of a copolymer polypropylene in the range of about 74.5-79.5 percent by weight;
an amount of magnesium silicate having a 15-35 mesh size in the range of about 20-25 percent by weight; and
an amount of colorant, added as needed to achieve a desired color.

11. The polymer blend of claim 10, further comprising a moisture content in the range of from 0.1% to 0.2% moisture.

12. The polymer blend of claim 10, wherein the copolymer polypropylene is comprised of regrind material.

13. The polymer blend of claim 10, wherein the blend has a melt flow rate of approximately 30 g/10 min (±2 g/10 min).

14. The polymer blend of claim 10, wherein the copolymer polypropylene comprises polypropylene monomer and ethylene propylene diene monomer (EPDM).

15. The polymer blend of claim 14, wherein the copolymer polypropylene is equivalent to automotive-grade PP/EPDM.

16. The polymer blend of claim 15, wherein the copolymer polypropylene is comprised of regrind material.
